(19) United States
(12) Patent Application Publication
(10) Pub. No.: US 2024/0406790 A1
(43) Pub. Date: Dec. 5, 2024

(54) DEVICE-TO-DEVICE RELAY COMMUNICATION

(71) Applicant: ZTE Corporation, Shenzhen (CN)

(72) Inventors: Mengzhen WANG, Shenzhen (CN); Lin CHEN, Shenzhen (CN); Weiqiang DU, Shenzhen (CN); Wanfu XU, Shenzhen (CN)

(21) Appl. No.: 18/798,414

(22) Filed: Aug. 8, 2024

Related U.S. Application Data
(63) Continuation of application No. PCT/CN2022/076136, filed on Feb. 14, 2022.

(51) Int. Cl. H04W 28/02; H04W 92/18

(52) U.S. Cl. CPC H04W 28/0268; H04W 28/0273; H04W 92/18

(57) ABSTRACT

Methods, apparatus, and systems that can facilitate the establishment of connections and management of QoS information in UE-to-UE relay sidelink communications are disclosed. In one example aspect, a method for wireless communication includes reporting, by a first communication device to a first base station, at least a first part of Quality of Service (QoS) information applicable between the first communication device and a relay communication device. The first communication device is configured to communicate with a second communication device via the relay communication device. The method also includes receiving, by the first communication device, sidelink configuration information that is based on at least the first part of QoS information from the first base station.

### CROSS REFERENCE TO RELATED APPLICATIONS

This patent document is a continuation of and claims benefit of priority to International Patent Application No. PCT/CN2022/076136 filed on Feb. 14, 2022. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that can be implemented in various embodiments to facilitate the establishment of connections and management of QoS information in UE-to-UE relay sidelink communications.

In one example aspect, a method for wireless communication includes reporting, by a first communication device to a first base station, at least a first part of Quality of Service (QoS) information applicable between the first communication device and a relay communication device. The first communication device is configured to communicate with a second communication device via the relay communication device. The method also includes receiving, by the first communication device, sidelink configuration information that is based on at least the first part of QoS information from the first base station.

In another example aspect, a method for wireless communication includes receiving, by a first base station from a first communication device, at least a first part of Quality of Service (QoS) information applicable between the first communication device and a relay communication device. The first communication device is configured to communicate with a second communication device via the relay communication device. The method also includes transmitting, by the first base station, sidelink configuration information that is based on at least the first part of the QoS information to the first communication device.

In another example aspect, a method for wireless communication includes receiving, by a first base station from a first communication device, Quality of Service (QoS) information applicable between the first communication device and a second communication device. The first communication device is configured to communicate with the second communication device via a relay communication device. The method also includes determining, by the first base station based on the QoS information applicable between the first communication device and a second communication device, a first part of QoS information applicable between the first communication device and the relay communication device and a second part of QoS information applicable between the relay communication device and the second communication device.

In another example aspect, a method for wireless communication includes receiving, by a relay communication device from a base station, sidelink configuration information that is based on at least a second part of Quality of Service (QoS) information applicable between the relay communication device and a second communication device, wherein the second communication device is configured to communicate with a first communication device via the relay communication device.

In another example aspect, a method for wireless communication includes transmitting, by a first communication device, configuration information for one or more sidelink radio bearers to a second communication device via a relay communication device. The configuration information includes an identifier applied in security protection of a transmission link between the first communication device and the second communication device. The method also includes establishing the one or more sidelink radio bearers based on the configuration information.

In another example aspect, a method for wireless communication includes receiving, by a second communication device, configuration information for one or more sidelink radio bearers from a first communication device via a relay communication device. The configuration information includes an identifier applied in security protection of a transmission link between the first communication device and the second communication device. The method also includes establishing the one or sidelink radio bearers based on the configuration information.

In another example aspect, a method for wireless communication includes detecting, by a relay communication device, a failure in an establishment of a connection between the relay communication device and a second communication device. The second communication device is configured to communicate with a first communication device via the relay communication device. The method also includes transmitting, by the relay communication device, a notification to the first communication device indicating the failure in the establishment of the connection.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates two example scenarios for sidelink relay communication.

FIG. 2 illustrates an example Layer 2 (L2) User Equipment (UE) to UE relay architecture.

FIG. 3 illustrates an example sequence flow of establishing a communication link between a source UE, a relay UE, and a target UE in accordance with one or more embodiments of the present technology.

FIG. 4 is a flowchart representation of a method for wireless communication in accordance with one or more embodiments of the present technology.

FIG. 5A is a flowchart representation of another method for wireless communication in accordance with one or more embodiments of the present technology.

FIG. 5B is a flowchart representation of another method for wireless communication in accordance with one or more embodiments of the present technology.

FIG. 6 illustrates an example establishment process for a source UE that is in the Radio Resource Control (RRC) connected state in accordance with one or more embodiments of the present technology.

FIG. 7 illustrates an example signaling sequence between the base stations, the source UE, and the relay UE in accordance with one or more embodiments of the present technology.

FIG. 8A is a flowchart representation of another method for wireless communication in accordance with one or more embodiments of the present technology.

FIG. 8B is a flowchart representation of another method for wireless communication in accordance with one or more embodiments of the present technology.

FIG. 9 is a flowchart representation of yet another method for wireless communication in accordance with one or more embodiments of the present technology.

FIG. 10 shows an example of a wireless communication system where techniques in accordance with one or more embodiments of the present technology can be applied.

FIG. 11 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

With the development of wireless multimedia services, demand for high data rate and better user experience increases, leading to more stringent requirements on system capacity and coverage of cellular networks. Various application scenarios, such as close-range data sharing, local advertising, etc., have also increased the need for proximity services. The traditional base station-centric cellular networks have shown limits in providing high data rates for proximity services.

Sidelink is an adaptation of the base station-centric communication technology that allows direct communication between two devices without going through a base station. That means cars, robots and even consumer gadgets can create their own ad hoc networks without using the radio access network as an intermediary. Sidelink communication technology is suitable to meet the requirements of high data rates for proximity services and to further reduce the burden of cellular networks, reduce battery power consumption of user equipment, and improve the robustness of network infrastructure. Sidelink communication can also interchangeably referred to as device-to-device (D2D) communication, Proximity Services (ProSe), unilateral communication, or sidechain communication.

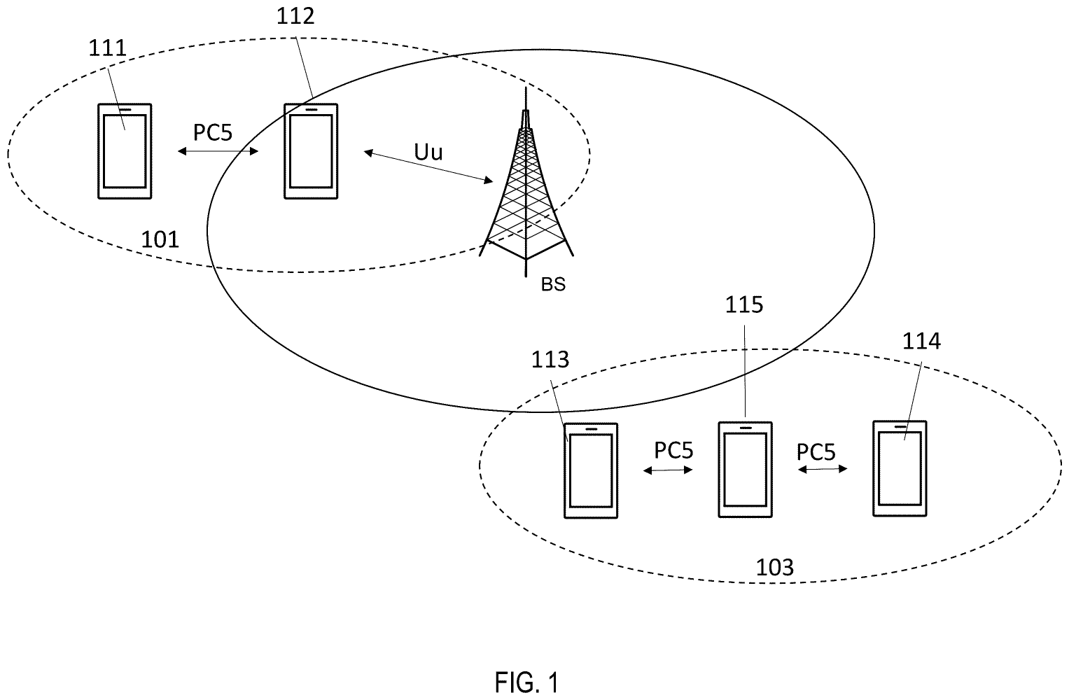

In order to support a wider range of applications and services, sidelink-based relay communication can extend coverage and improve power consumption, such as in indoor relay communication, smart agriculture, smart factories, public safety. FIG. 1 illustrates two example scenarios for sidelink relay communication.

### (1) User Equipment (UE) to Network Relay Scenario 101.

As shown in FIG. 1, UE 111 is in an area with poor signal quality or no coverage to communicate with the network. Sidelink communication allows UE 111 to communicate with the network via UE 112, thereby expanding coverage and increasing network capacity. In this scenario, UE 112 can be referred to as the UE-to-Network relay device, and UE 111 can be referred as the remote UE.

### (2) UE-to-UE Relay Scenario 103.

In some cases (e.g., in the event of a catastrophe or emergency), the cellular network cannot work normally. In order to expand the coverage range of the sidelink communication, multi-hop relay using one or more UE devices can be adopted. As shown in FIG. 1, UE 113 communicates with UE 114 through UE 115. Here, UE 115 can be referred to as the UE-to-UE relay device, and UE 113 and 114 can be referred to as remote UEs. Currently, however, there is no unified or standardized mechanism to establish a connection or to manage QoS requirements between a remote UE and a UE-to-UE relay device.

This patent document discloses techniques that can be implemented in various embodiments to facilitate the establishment of connections between remote UEs and one or more UE-to-UE relay devices. The disclosed techniques can also be used to manage the connection and ensure the quality of service between the remote UEs and the one or more UE-to-UE relay devices.

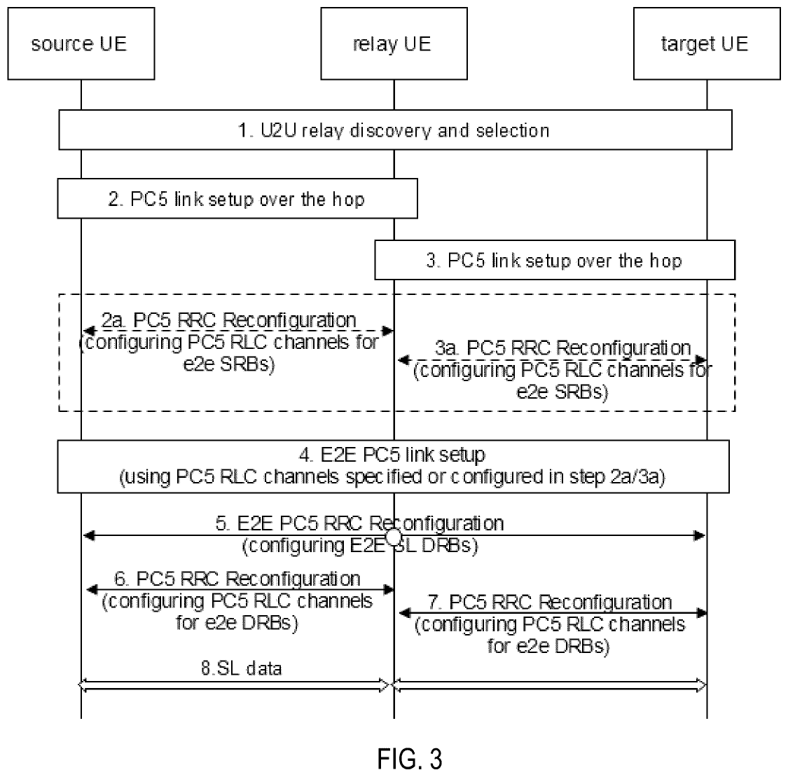

Some examples of the disclosed techniques shown in FIGS. 3-9 are further described in the following example Embodiments 1-3.

### Embodiment 1

In some embodiments, if two remote UE devices (e.g., a source UE and a target UE) are not in the sidelink communication range of each other, they can locate a third UE that is capable of UE-to-UE relay communication and within the communication range of both to forward sidelink traffic for them. Before the user data transmission, the source UE and the target UE need to discovery each other via the relay UE and establish an extended communication link via the relay UE (e.g., PC5 unicast link). In addition, the remote UEs and the relay UE need to prepare transmission channels (e.g., PC5 RLC channels) among themselves for relaying sidelink traffic.

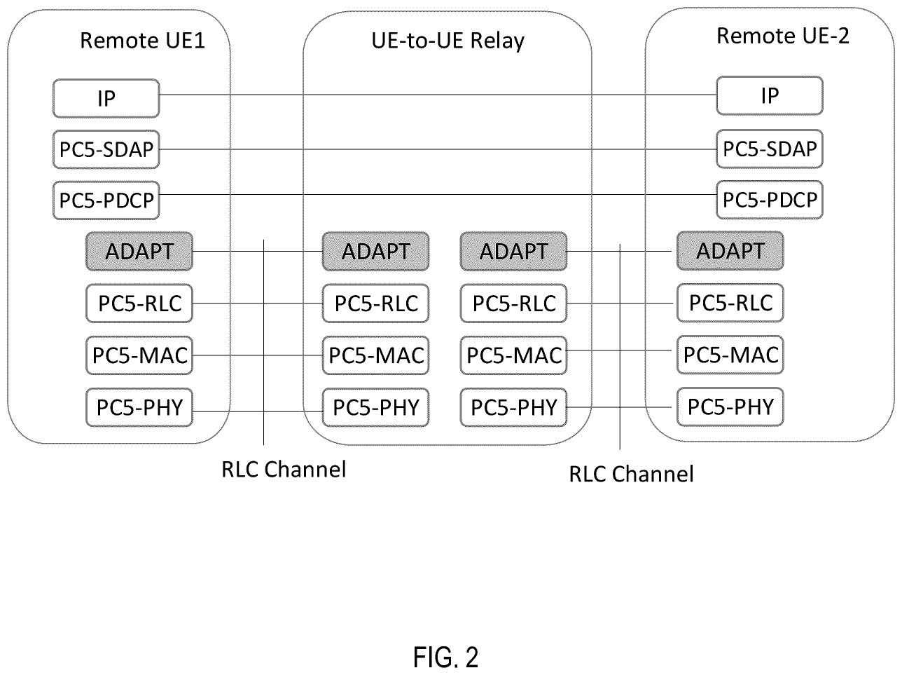

FIG. 2 illustrates an example Layer 2 (L2) UE-to-UE relay architecture. As shown in FIG. 2, the end-to-end PC5 Service Data Adaptation Protocol (SDAP) and Packet Data Convergence Protocol (PDCP) layers are terminated at source and target remote UEs (e.g., UE1 and UE2). The PC5 Radio Link Control (RLC), Medium Access Control (MAC), and Physical (PHY) layers are terminated at each hop. A PC5 adaptation layer (ADAPT) can be located above the PC5 RLC layer and terminated at each hop. The end-to-end sidelink (SL) Signaling Radio Bearers (SRBs) and/or Data Radio Bearers (DRBs) are transmitted over the PC5 RLC bearers/channels between the source UE (e.g., remote UE1) and the UE-to-UE relay UE, and between the UE-to-UE relay UE and the target UE (e.g., remote UE2).

FIG. 3 illustrates an example sequence flow of establishing a communication link between a source UE, a relay UE, and a target UE in accordance with one or more embodiments of the present technology. In operation 1, the source UE tries to discover a UE-to-UE relay device to reach the target UE. The discovery of the relay device can also trigger the relay device to discover the target UE. If the source UE discovers multiple relay UEs, the source UE can select one of them as the relay UE for establishing the connection to the target UE.

In operations 2 and 3, after the discovery and selection of the relay UE, the connection (e.g., PC5 unicast link) between the source UE and the relay UE and the connection (e.g., PC5 unicast link) between the relay UE and the target UE are established respectively. If the establishment of any one of the connections fails, the relay UE can inform the remote UE(s) of the failure. For example, if the establishment of the second hop connection (e.g., PC5 unicast link between the relay UE and target UE) fails, the relay UE informs the source UE of the failure.

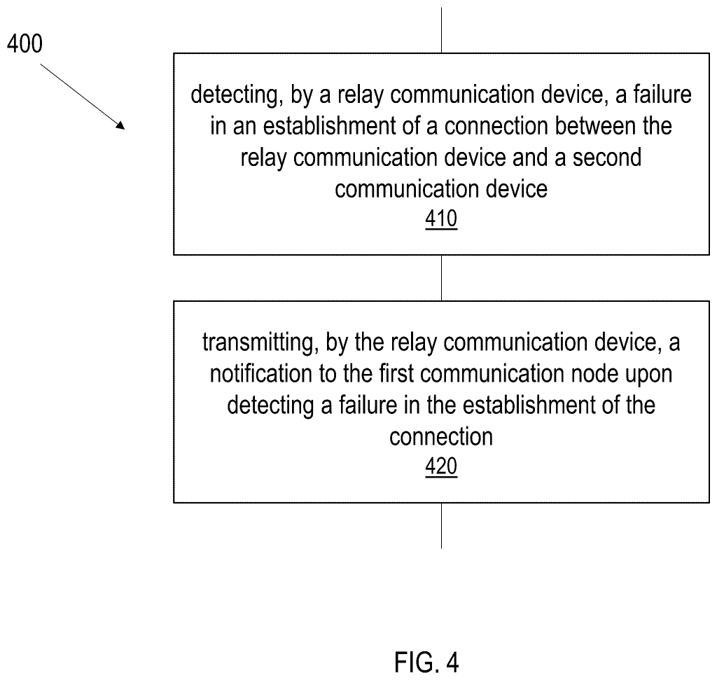

FIG. 4 is a flowchart representation of a method 400 for wireless communication in accordance with one or more embodiments of the present technology. The method 400 includes, at operation 410, detecting, by a relay communication device, a failure in an establishment of a connection between the relay communication device and a second communication device. The second communication device is configured to communicate with a first communication device via the relay communication device. The method 400 includes, at operation 420, transmitting, by the relay communication device, a notification to the first communication node indicating the failure in the establishment of the connection. In some embodiments, the notification comprises a failure indication or an identifier of the second communication device. For example, remote UE1 wants to communicate with other remote UEs, including UE2, UE3 and UE4, and initiates connection establishment to UE2, UE3, and UE4 via the relay UE. During the establishment of connections, the relay UE detects a connection failure with UE3. The relay UE informs UE1 of the failure using a failure notification. The notification can include an identifier of UE3 so that UE1 understands the connection towards UE3 fails (not the connections towards UE2 and/or UE4). In some embodiments, the notification is one of a PC5 link setup response, a direct communication response, a PC5 link release message, an L2 link release message, or a PC5 RRC signaling to the source UE.

Referring back to FIG. 3, to set up a secured extended PC5 unicast link, direct communication request (SL SRB0), direct link security mode command and direct link security mode complete (SL SRB1) and direct communication response (SL SRB2) messages need to be exchanged between source UE and target UE. To transmit these messages, the PC5 RLC bearers in first hop and second hop need to be established first. In some embodiments, specific PC5 RLC bearers can be used to transmit end-to-end SL SRBs. For example, one PC5 RLC bearer can be used to transmit all end-to-end SL SRBs (e.g., SRB 0/1/2). As another example, separate PC5 RLC bearers can be used to transmit each end-to-end SL SRB respectively. In some embodiments, configured PC5 RLC bearers are used to transmit end-to-end SL SRBs. That is, PC5 RRC reconfiguration is performed at each hop to configure the PC5 RLC bearers. In some embodiments, one PC5 RLC bearer can be configured to transmit all end-to-end SL SRBs (e.g., SRB 0/1/2). Alternatively, or in addition, separate PC5 RLC bearers can be configured to transmit each end-to-end SL SRB respectively.

If one PC5 RLC bearer (specific or configured) is used to transmit all end-to-end SL SRBs, the adaptation layer in both first hop and second hop includes both UE identity and end-to-end SL SRB identity to identify the source UE and/or the target UE, as well as to identify the specific end-to-end SL SRB. If separate PC5 RLC bearers are used to transmit each end-to-end SL SRBs, only UE identity needs to be included in adaptation layer in first hop and second hop to identify the source UE and/or target UE. The end-to-end SL SRB can be identified by the dedicated PC5 RLC bearer that it maps to. In operation 4, the secured extended PC5 unicast link is then established between the source UE and the target UE via the relay UE.

In operation 5, after the secured extended PC5 unicast link is established between source UE and target UE, end-to-end SL DRBs can be configured via PC5 RRC reconfiguration to transmit data traffic between the source UE and the target UE. To ensure secure transmission between the communication devices, the Third-Generation Partnership Project (3GPP) has provided different mechanisms for the security protection of the sidelink communication. For example, for 5G sidelink communication, the ciphering and deciphering function can be performed based on at least a key and a bearer identifier (ID). Furthermore, integrity protection and verification of the SL radio bearers can be performed based on parameters such as a bearer ID. In legacy direct SL communication, SL logical channel identity (LCID) is exchanged between the two direct communicating UEs. The LSB 5 bits of the LCID is used as an input of security algorithms. However, in the UE-to-UE relay architecture, while the PDCP entity is terminated at source UE and target UE, there is no single direct SL logical channel used between the UEs as different logical channels are used in the first hop and second hop.

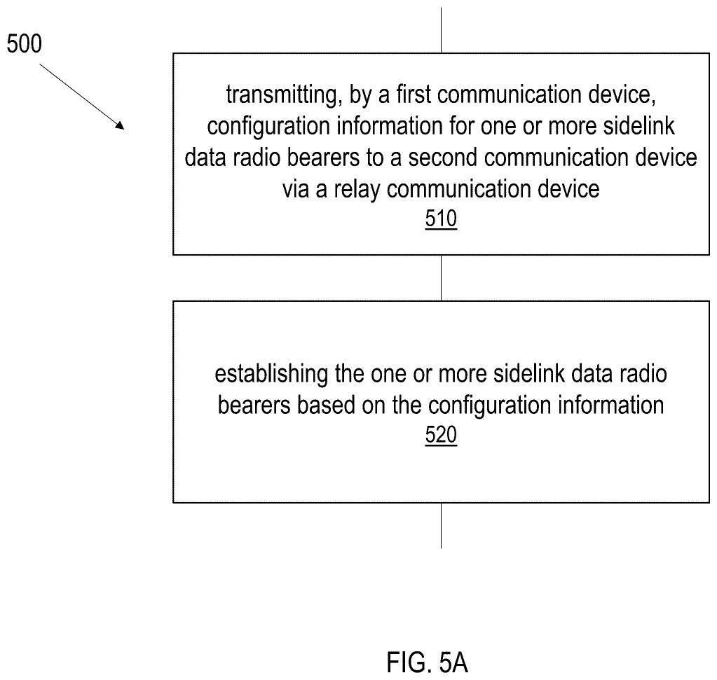

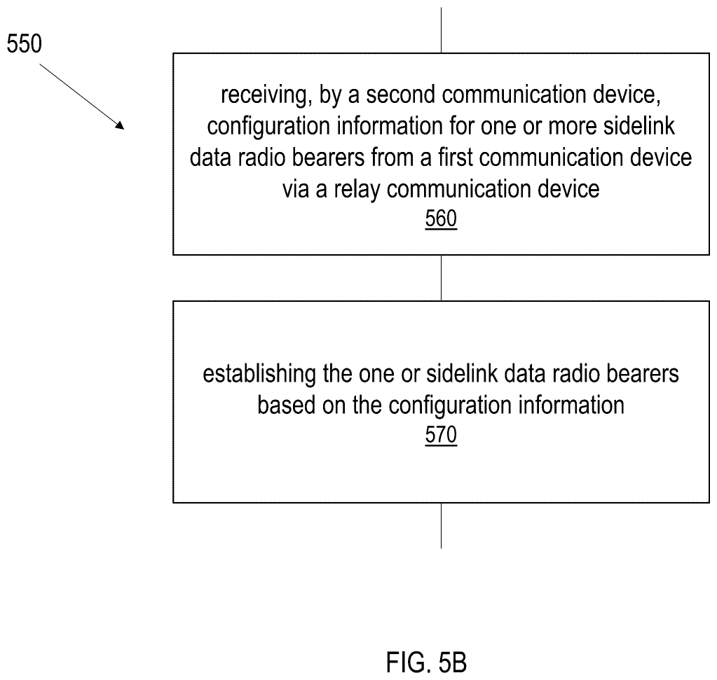

To address this problem, a virtual or a fictious ID can be used in configuration the end-to-end SL DRBs. FIG. 5A is a flowchart representation of a method for wireless communication in accordance with one or more embodiments of the present technology. The method 500 includes, at operation 510, transmitting, by a first communication device, configuration information for one or more sidelink data radio bearers to a second communication device via a relay communication device. The configuration information includes an identifier applied in security protection of a transmission link between the first communication device and the second communication device. The method 500 includes, at operation 520, establishing the one or more sidelink data radio bearers based on the configuration information. FIG. 5B is a flowchart representation of a method for wireless communication in accordance with one or more embodiments of the present technology. The method 550 includes, at operation 560, receiving, by a second communication device, configuration information for one or more sidelink data radio bearers from a first communication device via a relay communication device. The configuration information includes an identifier applied in security protection of a transmission link between the first communication device and the second communication device. The method 550 also includes, at operation 570, establishing the one or sidelink data radio bearers based on the configuration information. In some embodiments, the identifier comprises a fictitious radio bearer identifier or a fictitious logical channel identifier. The security protection comprises at least one of a ciphering function, a deciphering function, an integrity protection function, or an integrity verification function.

Referring back to FIG. 3, the end-to-end SL DRB configuration information can include at least one of sidelink SDAP/PDCP configuration, a virtual/fictitious end-to-end bearer ID or a virtual/fictitious logical channel ID. In some embodiments, the least significant N bits (e.g., 5 bits) of the virtual/fictious end-to-end ID are used as the input to the security protection functions or algorithms. Alternatively, or in addition, the least significant N bits of the bearer ID/index of the end-to-end SL DRB can be used as the input to the security protection functions or algorithms. In some embodiments, the fictitious/virtual ID (e.g., bearer ID and/or the logical channel ID) can be included in PDCP header or adapt layer header that is transmitted to the target UE by the source UE.

In operations 6 and 7, PC5 RLC bearers in first hop and second hop are configured to transmit the end-to-end SL DRBs. At the source UE, the mapping relationship between the end-to-end SL DRB and the ingress PC5 RLC bearer can be configured by the source UE's serving gNB or by pre-configuration. At the relay UE, the mapping relationship between the end-to-end SL DRB and the egress PC5 RLC bearers, or the mapping relationship between the ingress PC5 RLC bearer and the egress PC5 RLC bearer can be configured by the relay UE's serving gNB or by pre-configuration. Alternatively, or in addition, the relay UE maps the data traffic of the end-to-end SL DRB/ingress PC5 RLC bearer to egress PC5 RLC bearer according to the information carried in adaption layer header. The information carried in adaption layer header can be the Quality of Service (QoS) priority, the PC5 QoS Identifier (PQI) of the end-to-end SL DRB, or the logical channel priority of the ingress PC5 RLC bearer.

After the PC5 RLC bearers in first hop and second hop are prepared, source UE and target UE can transmit data traffic via the relay UE.

### Embodiment 2

This embodiment discloses techniques related to the QoS control for UE-to-UE relay scenario. For the UE-to-UE relay scenario, the source UE decides the end-to-end QoS parameters between the source UE and the target UE based on the application layer requirements. The end-to-end QoS parameters, especially the Packet Delay Budget (PDB), needs to be split between the two hops (e.g., the two PC5 interfaces). In some embodiments, the relay UE splits the end-to-end QoS parameters into two parts: the first part includes the source-side QoS parameters between the source UE and the relay UE, and the second part includes the target-side QoS parameters between the relay UE and the target UE. The relay UE ensures the PDB and Packet Error Rate (PER) associated with the PQI in the source-side QoS parameters and the PDB and PER associated with the PQI in the target-side QoS parameters support the end-to-end PDB requirements between source UE and target UE. The relay UE also ensures other QoS parameters/QoS characteristics in the source-side QoS parameters and the target-side QoS parameters are compatible. For example, the source-side QoS parameters and the target-side QoS parameters can have the same values for compatibility. In some embodiments, the relay UE's decision can be based on the local policy or the low layer measurements.

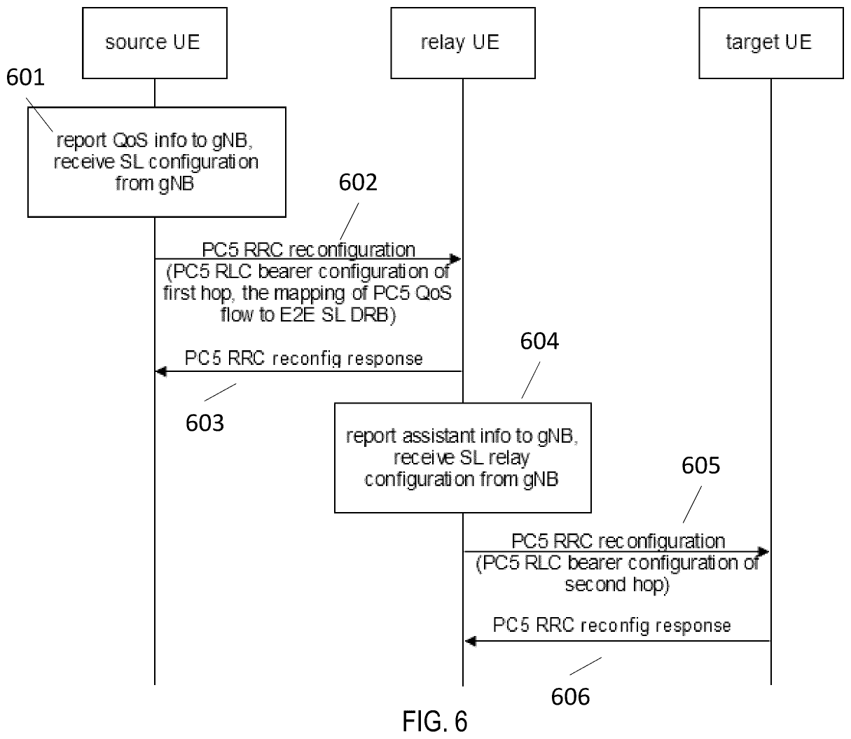

Before data transmission occurs between the source UE and the target UE via the relay UE, the end-to-end SL DRBs and PC5 RLC bearers in the two PC5 hops/interfaces need to be established first. FIG. 6 illustrates an example establishment process for a source UE that is in the Radio Resource Control (RRC) connected state in accordance with one or more embodiments of the present technology. When the source UE is in RRC connected state, the source UE reports, at operation 601, the end-to-end QoS information, the source-side PC5 QoS parameters for each target UE, and/or the relay UE information to its base station (e.g., gNB) to obtain sidelink configuration from the gNB. Specifically, the source UE reports QoS information of a list of PC5 QoS flows to gNB. The list of PC5 QoS flows includes at least one of QoS Flow Identifier (QFI), end-to-end PC5 QoS profile, and/or source side PC5 QoS profile of each PC5 QoS flow. The source side PC5 QoS profile includes at least one of the PQI, the resource type, the priority level, the PDB, the PER, the averaging window, the maximum data burst volume, the range, the Guaranteed Flow Bit Rate (GFBR), and/or the Minimum Flow Bit Rate (MFBR). The relay UE information includes at least a Layer 2 (L2) identifier of the relay UE and/or the relay UE's serving cell ID, NR Cell Global Identifier (NCGI), gNB ID, and/or Cell Global Identifier (CGI).

Taking the information into account, the gNB that serves the source UE performs sidelink configuration of each target UE. Specifically, the sidelink configuration per target UE can include at least one of: end-to-end SL DRB configuration (including end-to-end SL SDAP and PDCP configuration), PC5 RLC bearer configuration of the first hop (on the source side), adaptation layer configuration, SL mode 1 resource allocation, and/or SL configured grant type 1 resource allocation. The adaptation layer configuration includes at least one of: an end-to-end SL DRB identity, the egress PC5 RLC bearer identity (e.g., the PC5 RLC bearer over the first hop/between source UE and relay UE), and/or an adaptation layer discard timer. The adaptation layer configuration further indicates the mapping of E end-to-end 2E SL DRB and egress PC5 RLC bearer. The PC5 RLC bearer configuration can include the associated PC5 QoS (e.g., at least one of the PDB, the PER, the PQI, the priority level, the resource type, the averaging window, and/or the maximum data burst volume). After receiving the sidelink configuration from the gNB, the source UE sends the PC5 RLC bearer configuration to the relay UE at operation 602 and optionally receives response message from the relay UE at operation 603.

If the relay UE is also in the RRC connected state, the relay UE can report assistance information to the gNB and/or acquire SL relay configuration from its gNB at operation 604. The SL relay configuration can include the adaptation layer configuration and PC5 RLC bearer configuration of the second hop between relay UE and target UE (e.g., egress PC5 RLC bearer). In some embodiments, to assist the gNB to determine configuration information (e.g., for the second hop SL configuration), the relay UE can acquire and report to gNB at least one of the PC5 RLC bearer configuration of first hop (e.g., ingress PC5 RLC bearer configuration), the mapping between the PC5 QoS flows and end-to-end SL DRBs, or the mapping between the end-to-end SL DRBs and PC5 RLC bearer from source UE. In addition, the relay UE can report the end-to-end PC5 QoS and/or the target side PC5 QoS parameters to its gNB. Such information can be obtained by the relay UE from the source via PC5 RRC signaling.

In addition, the source UE can transmit to the relay UE the PQI or PFI in the adaptation layer header. The adaptation layer configuration can include at least one of: an end-to-end SL DRB identity, the ingress PC5 RLC bearer identity (e.g., the PC5 RLC bearer over the first hop/between source UE and relay UE), the egress PC5 RLC bearer identity (e.g., the PC5 RLC bearer over the second hop/between relay UE and target UE), and/or an adaptation layer discard timer. The adaptation layer configuration further indicates the mapping of end-to-end SL DRB and egress PC5 RLC bearer, or the mapping of ingress PC5 RLC bearer and egress PC5 RLC bearer. The PC5 RLC bearer configuration can include the associated PC5 QoS (e.g., at least one of the PDB, the PER, the PQI, the priority level, the resource type, the averaging window, and/or the maximum data burst volume).

After receiving SL relay configuration from gNB, the relay UE can send the PC5 RLC bearer configuration to target UE at operation 604 and optionally receives response message from the target UE at operation 605.

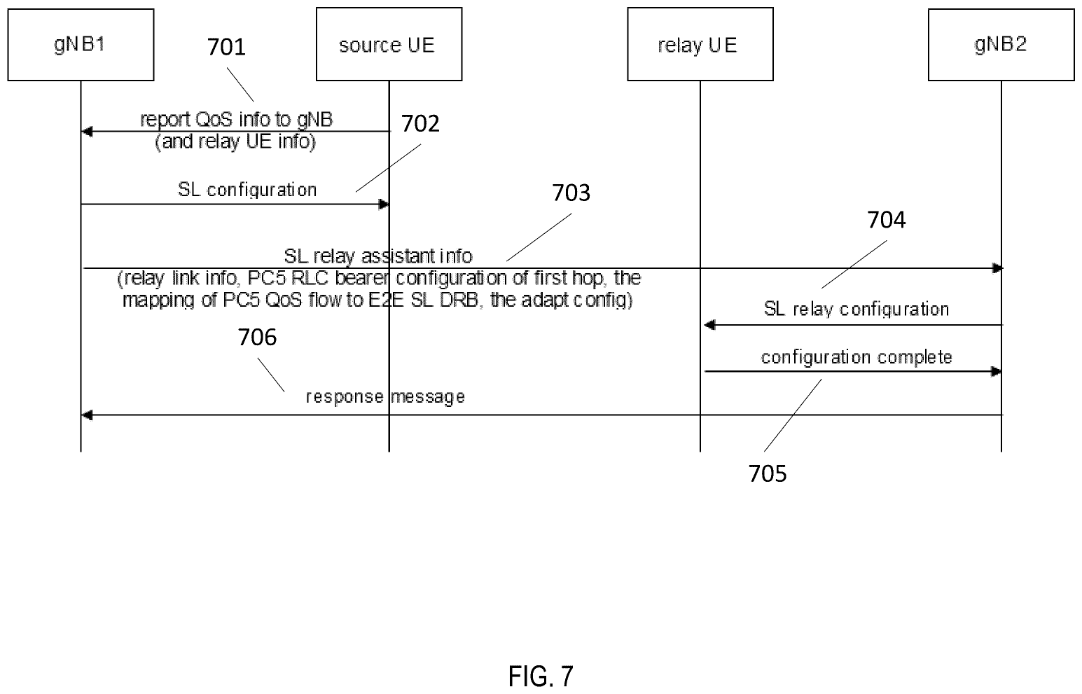

In some embodiments, when receiving QoS information and relay UE information from the source UE, the gNB1 that is the serving base station of the source UE recognizes gNB2, the serving base station of the relay UE. FIG. 7 illustrates an example signaling sequence between the base stations, the source UE, and the relay UE in accordance with one or more embodiments of the present technology. At operation 701, the source UE reports the end-to-end QoS information, the source-side PC5 QoS parameters for each target UE, and the relay UE information to gNB1 to obtain sidelink configuration from the gNB1. Specifically, the source UE reports QoS information of a list of PC5 QoS flows to gNB1. The list of PC5 QoS flows includes at least one of QFI, end-to-end PC5 QoS profile, and/or source side PC5 QoS profile of each PC5 QoS flow. The source side PC5 QoS profile includes at least one of the PQI, the resource type, the priority level, the PDB, the PER, the averaging window, the maximum data burst volume, the range, the GFBR, and/or the MFBR. The gNB1 sends SL configuration information to the source UE accordingly at operation 702.

The gNB1 can also send the SL relay assistance information to the gNB2 at operation 703 such that the gNB2 can determine configuration for the relay UE. The SL relay assistance information can include at least one of: the source UE identity such as the L2 UE ID, the local ID, or the Cell Radio Network Temporary Identifier (C-RNTI), PC5 RLC bearer configuration for the source UE, the mapping of PC5 QoS flows to end-to-end SL DRBs for the source UE, the mapping of end-to-end SL DRBs to PC5 RLC bearer, the relay UE identity such as the L2 UE ID or the C-RNTI, relay indication, the target UE identity such as the L2 UE ID or the C-RNTI, and/or the end-to-end PC5 QoS profile. The gNB1 can send the information via the Xn interface. For example, existing Xn messages, such as the handover request, the Xn setup request, the NG-RAN node configuration update, or the resource status request, etc. can be used. In some embodiments, new Xn messages can be designed to carry such information.

The gNB2 identifies the relay UE and configures the relay UE accordingly. Specifically, the gNB2 sends the SL relay configuration to relay UE at operation 704. In some embodiments, the gNB1 also serves the relay UE, and can send the SL relay configuration to the relay EU directly. The SL relay configuration includes at least one of: the adaptation layer configuration and/or the PC5 RLC bearer configuration of the second hop between relay UE and target UE (e.g., egress PC5 RLC bearer). The adaptation layer configuration includes at least one of: the end-to-end SL DRB identity, the ingress PC5 RLC bearer identity (e.g., the PC5 RLC bearer over the first hop/between source UE and relay UE), the egress PC5 RLC bearer identity (e.g., the PC5 RLC bearer over the second hop/between relay UE and target UE), and/or an adaptation layer discard timer. The PC5 RLC bearer configuration includes the associated PC5 QoS information (e.g., at least one of the PDB, the PER, the PQI, the priority level, the resource type, the averaging window, and/or the maximum data burst volume). After receiving SL relay configuration from gNB2, the relay UE can send a configuration complete message to gNB2 at operation 705. The gNB2 can send a response message to the gNB1 at operation 706 after completion of configuration for relay UE.

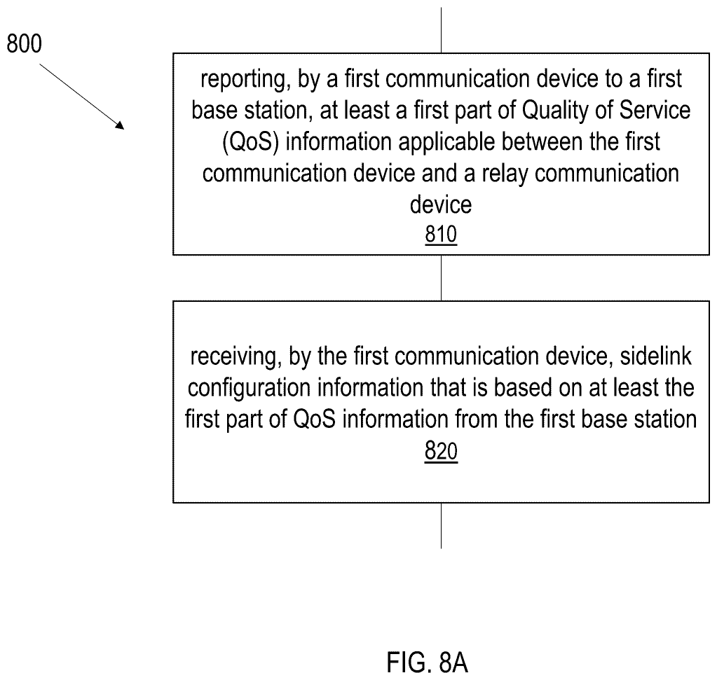

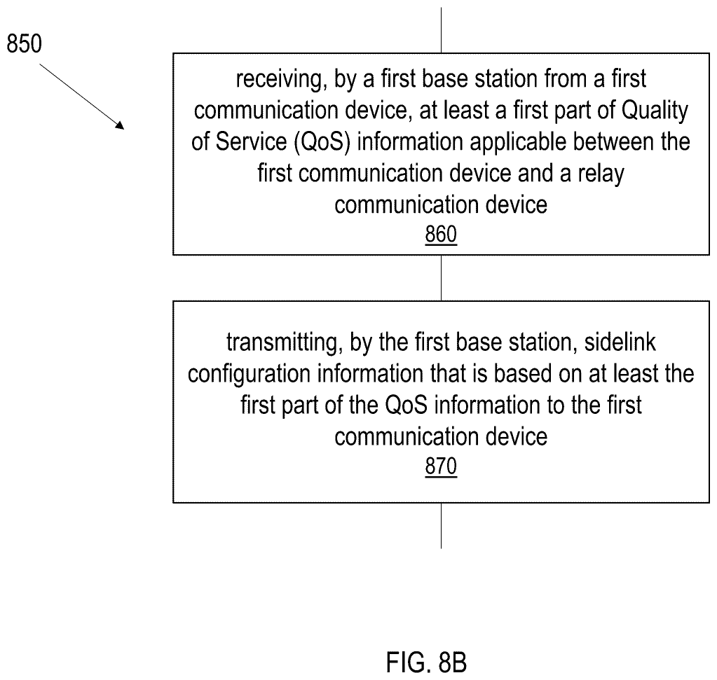

FIG. 8A is a flowchart representation of a method for wireless communication in accordance with one or more embodiments of the present technology. The method 800 includes, at operation 810, reporting, by a first communication device to a first base station, at least a first part of Quality of Service (QoS) information applicable between the first communication device and a relay communication device. The first communication device is configured to communicate with a second communication device via the relay communication device. The method 800 includes, at operation 820, receiving, by the first communication device, sidelink configuration information that is based on at least the first part of QoS information from the first base station. In some embodiments, the method also includes transmitting, by the first communication device, bearer configuration information to the relay communication device based on at least the sidelink configuration information.

FIG. 8B is a flowchart representation of a method for wireless communication in accordance with one or more embodiments of the present technology. The method 850 includes, at operation 860, receiving, by a first base station from a first communication device, at least a first part of Quality of Service (QoS) information applicable between the first communication device and a relay communication device. The first communication device is configured to communicate with a second communication device via the relay communication device. The method 850 includes, at operation 870, transmitting, by the first base station, sidelink configuration information that is based on at least the first part of the QoS information to the first communication device.

In some embodiments, the receiving of operation 860 comprises receiving a second part of QoS information applicable between the relay communication device and the second communication device (e.g., from the first communication device or from the relay communication device). The method further includes transmitting, by the first base station to the relay communication device, sidelink configuration information that is based on the second part of QoS information. In some embodiments, the method includes transmitting, by the first base station, relay assistance information to a second base station (e.g., the base station configured to serve the relay communication device).

When the source UE or the relay UE is in the RRC inactive/idle state, the source UE or the relay UE can acquire the SL relay related configuration from system information. That is, the system information broadcast by the base station(s) can include SL relay related configuration. The SL relay related configuration includes at least one of: the end-to-end SL DRB configuration, adaptation layer configuration, and/or PC5 RLC bearer configuration. The end-to-end SL DRB configuration for each end-to-end SL DRB can be associated with a list of end-to-end PC5 QoS profiles mapped to the end-to-end SL DRB. The adaptation layer configuration can include at least one of: an end-to-end SL DRB identity, an ingress PC5 RLC bearer identity (e.g., the PC5 RLC bearer over the first hop/between source UE and relay UE), the egress PC5 RLC bearer identity (e.g., the PC5 RLC bearer over the second hop/between the relay UE and the target UE, or the PC5 RLC bearer over first hop), an adaptation layer discard timer, the associated a list of end-to-end PC5 QoS profiles, the associated a list of PC5 QoS profiles of first hop, and/or the associated a list of PC5 QoS profiles of second hop. The PC5 RLC bearer configuration can include the bearer identity, the associated a list of PC5 QoS profiles. Each PC5 QoS profile can include at least one of the PDB, the PER, the PQI, the priority level, the resource type, the averaging window, and/or the maximum data burst volume.

In some embodiments, if the source UE or the relay UE is out of the coverage area, the source UE or the relay UE can be preconfigured with SL relay related pre-configuration information. The SL relay related pre-configuration can include at least one of: the end-to-end SL DRB configuration, the adaptation layer configuration, and/or PC5 RLC bearer configuration.

### Embodiment 3

In some embodiments, the serving base station for the source UE (e.g., gNB1) can determine how to split the end-to-end QoS parameters into two parts. If the source UE is in RRC connected state, it can send the end-to-end PC5 QoS to its serving base station gNB1. The gNB1 splits the end-to-end PC5 QoS into two parts: the first part includes the source-side QoS parameters between the source UE and the relay UE, and the second part includes the target-side QoS parameters between the relay UE and the target UE. The gNB1 then sends SL configuration to source UE. The SL configuration includes at least one of the split PC5 QoS information (e.g., the first part and/or the second part), the end-to-end SLRB configuration, the first hop PC5 RLC bearer configuration, and/or the adaptation layer configuration. The split PC5 QoS information includes at least one of the PDB of first hop, the PDB of second hop, and/or other PC5 QoS parameters of the second hop (e.g., the PQI, the resource type, the priority level, the PER, the averaging window, the maximum data burst volume, the range, the GFBR, and/or the MFBR). After receiving SL configuration from gNB1, source UE sends the split PC5 QoS information (e.g., the PDB of second hop and optionally other PC5 QoS parameters) to the relay UE. If the relay UE is in the RRC connected state, it can send the split PC5 QoS to its serving gNB (e.g., gNB2) and obtain SL relay configuration from the gNB2.

In some embodiments, when receiving PC5 QoS information and relay UE information from source UE, the serving gNB of source UE (e.g., gNB1) recognizes the relay UE's serving gNB (e.g., gNB2). The gNB1 can send split PC5 QoS information to the gNB2 so that the gNB2 can configure the relay UE. In some embodiments, if the relay UE is in coverage of the source UE's serving gNB (e.g., gNB1), the gNB1 can send split PC5 QoS directly to the relay UE. The gNB1 can also send the adaptation layer configuration and PC5 RLC bearer configuration of second hop to the relay UE.

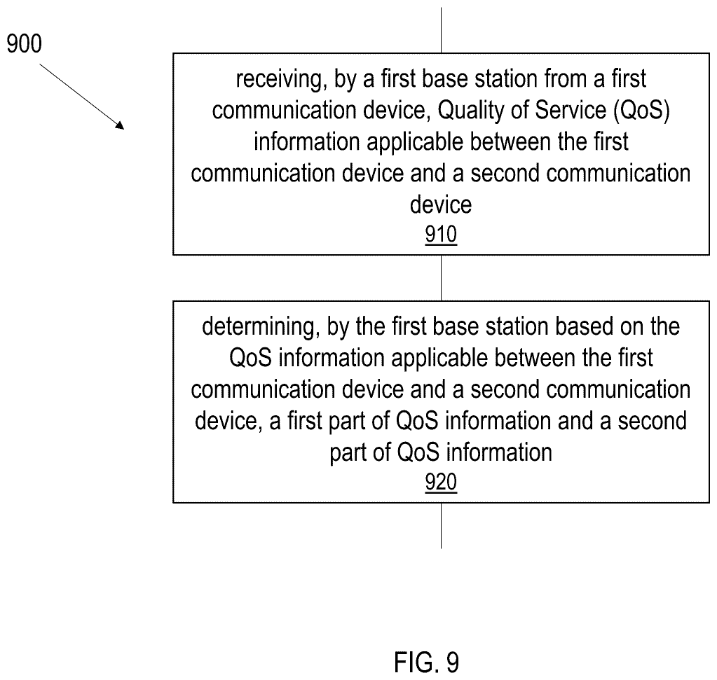

FIG. 9 is a flowchart representation of a method for wireless communication in accordance with one or more embodiments of the present technology. The method 900 includes, at operation 910, receiving, by a first base station from a first communication device, Quality of Service (QoS) information applicable between the first communication device and a second communication device. The first communication device is configured to communicate with the second communication device via a relay communication device. The method 900 includes, at operation 920, determining, by the first base station based on the QoS information applicable between the first communication device and a second communication device, a first part of QoS information applicable between the first communication device and the relay communication device and a second part of QoS information applicable between the relay communication device and the second communication device. In some embodiments, the method also includes transmitting, by the first base station, at least one of the first part of QoS information or the second part of QoS information to the first communication device.

Some embodiments may preferably implement the following solutions. A set of preferred solutions may include the following (e.g., as described with reference to Embodiments 1-3).

1. A method for wireless communication, comprising: reporting, by a first communication device to a first base station, at least a first part of Quality of Service (QoS) information applicable between the first communication device and a relay communication device, wherein the first communication device is configured to communicate with a second communication device via the relay communication device; and receiving, by the first communication device, sidelink configuration information that is based on at least the first part of QoS information from the first base station.

2. The method of solution 1, further comprising: transmitting, by the first communication device, bearer configuration information to the relay communication device based on at least the sidelink configuration information.

3. A method for wireless communication, comprising: receiving, by a first base station from a first communication device, at least a first part of Quality of Service (QoS) information applicable between the first communication device and a relay communication device, wherein the first communication device is configured to communicate with a second communication device via the relay communication device; and transmitting, by the first base station, sidelink configuration information that is based on at least the first part of the QoS information to the first communication device.

4. The method of solution 3, wherein the receiving comprises receiving a second part of QoS information applicable between the relay communication device and the second communication device from the first communication device or from the relay communication device, and the method further comprises transmitting, by the first base station to the relay communication device, sidelink configuration information that is based on the second part of QoS information.

5. A method for wireless communication, comprising: receiving, by a first base station from a first communication device, Quality of Service (QoS) information applicable between the first communication device and a second communication device, wherein the first communication device is configured to communicate with the second communication device via a relay communication device; and determining, by the first base station based on the QoS information applicable between the first communication device and a second communication device, a first part of QoS information applicable between the first communication device and the relay communication device and a second part of QoS information applicable between the relay communication device and the second communication device.

6. The method of solution 5, comprising: transmitting, by the first base station, at least one of the first part of QoS information or the second part of QoS information to the first communication device.

7. The method of any of solution 3 to 6, further comprising: transmitting, by the first base station, relay assistance information to a second base station.

8. A method for wireless communication, comprising: receiving, by a relay communication device from a base station, sidelink configuration information that is based on at least a second part of Quality of Service (QoS) information applicable between the relay communication device and a second communication device, wherein the second communication device is configured to communicate with a first communication device via the relay communication device.

9. The method of solution 8, further comprising reporting, by the relay communication device, relay assistance information to the base station, the relay assistance information comprising at least the second part of QoS information.

10. The method of solution 8, comprising transmitting, by the relay communication device, bearer configuration information to the second communication device based on the sidelink configuration information.

11. The method of any of solution 1 to 10, wherein the QoS information comprises information about one or more QoS flows, the information comprising at least one of a Qos Flow identifier or a QoS profile associated with a flow, wherein the QoS profile comprises at least one of a PC5 QoS Identifier (PQI), a resource type, a priority level, a packet delay budget, a packet error rate, an averaging window, a maximum data burst volume, a Guaranteed Flow Bit Rate (GFBR), or a Maximum Flow Bit Rate (MFBR).

12. The method of any of solution 1 to 11, wherein the first part of QoS information includes a packet delay budget that indicates an upper bound value for a packet delay between the first communication device and the relay communication device, and wherein the second part of QoS information includes a packet delay budget that indicates an upper bound value for a packet delay between the relay communication device and the first communication device.

13. The method of any of solution 1 to 12, wherein the sidelink configuration information comprises at least one of: a Service Data Adaptation Protocol (SDAP) configuration of a sidelink data radio bearer (DRB) between the first communication device and the second communication device, a Packet Data Convergence Protocol (PDCP) configuration of the sidelink DRB between the first communication device and the second communication device, a PC5 Radio Link Control (RLC) bearer configuration between the first communication device and the relay communication device or between the relay communication device and the second communication device, an adaptation layer configuration, a sidelink mode 1 resource allocation, or a sidelink configured grant type 1 resource allocation.

14. The method of any of solution 1 to 13, wherein the relay assistance information comprises at least one of the second part of QoS information, an identity of the first communication device, a PC5 RLC bearer configuration for first communication device, a mapping of one or more PC5 QoS flows to one or more sidelink DRBs between the first communication device and the second communication device, a mapping of the one or more sidelink DRBs between the first communication device and the second communication device to one or more PC5 RLC bearers, an identity of the relay communication device, a relay indication, an identity of the second communication device, or a PC5 QoS profile.

15. A method for wireless communication, comprising transmitting, by a first communication device, configuration information for one or more sidelink radio bearers to a second communication device via a relay communication device, wherein the configuration information includes an identifier applied in security protection of a transmission link between the first communication device and the second communication device; and establishing the one or more sidelink radio bearers based on the configuration information.

16. A method for wireless communication, comprising receiving, by a second communication device, configuration information for one or more sidelink radio bearers from a first communication device via a relay communication device, wherein the configuration information includes an identifier applied in security protection of a transmission link between the first communication device and the second communication device; and establishing the one or sidelink radio bearers based on the configuration information.

17. The method of solution 15 or 16, wherein the identifier comprises a fictitious radio bearer identifier or a fictitious logical channel identifier.

18. The method of any of solution 15 to 17, wherein the security protection comprises at least one of a ciphering function, a deciphering function, an integrity protection function, or an integrity verification function.

19. A method for wireless communication, comprising detecting, by a relay communication device, a failure in an establishment of a connection between the relay communication device and a second communication device, wherein the second communication device is configured to communicate with a first communication device via the relay communication device; and transmitting, by the relay communication device, a notification to the first communication device indicating the failure in the establishment of the connection.

20. The method of solution 19, wherein the notification comprises at least one of a failure indication or an identifier of the second communication device.

21. A communication apparatus, comprising a processor configured to implement a method recited in any one or more of claims 1 to 20.

22. A computer program product having code stored thereon, the code, when executed by a processor, causing the processor to implement a method recited in any one or more of claims 1 to 20.

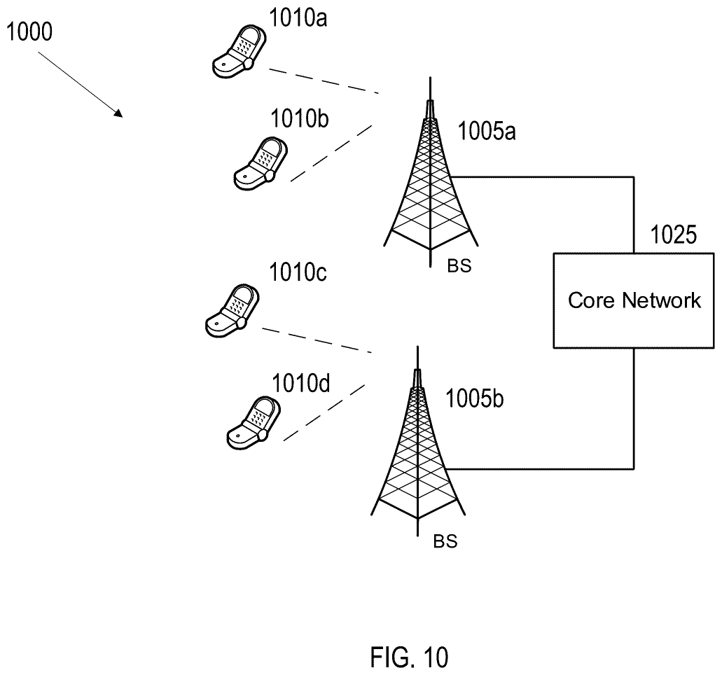

FIG. 10 shows an example of a wireless communication system 1000 where techniques in accordance with one or more embodiments of the present technology can be applied. A wireless communication system 1000 can include one or more base stations (BSs) 1005a, 1005b, one or more wireless devices (or UEs) 1010a, 1010b, 1010c, 1010d, and a core network 1025. A base station 1005a, 1005b can provide wireless service to user devices 1010a, 1010b, 1010c and 1010d in one or more wireless sectors. In some implementations, a base station 1005a, 1005b includes directional antennas to produce two or more directional beams to provide wireless coverage in different sectors. The core network 1025 can communicate with one or more base stations 1005a, 1005b. The core network 1025 provides connectivity with other wireless communication systems and wired communication systems. The core network may include one or more service subscription databases to store information related to the subscribed user devices 1010a, 1010b, 1010c, and 1010d. A first base station 1005a can provide wireless service based on a first radio access technology, whereas a second base station 1005b can provide wireless service based on a second radio access technology. The base stations 1005a and 1005b may be co-located or may be separately installed in the field according to the deployment scenario. The user devices 1010a, 1010b, 1010c, and 1010d can support multiple different radio access technologies. The techniques and embodiments described in the present document may be implemented by the base stations of wireless devices described in the present document.

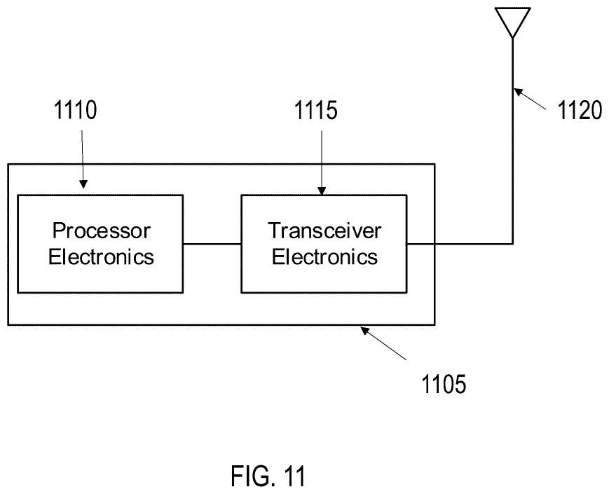

FIG. 11 is a block diagram representation of a portion of a radio station in accordance with one or more embodiments of the present technology can be applied. A radio station 1105 such as a network node, a base station, or a wireless device (or a user device, UE) can include processor electronics 1110 such as a microprocessor that implements one or more of the wireless techniques presented in this document. The radio station 1105 can include transceiver electronics 1115 to send and/or receive wireless signals over one or more communication interfaces such as antenna 1120. The radio station 1105 can include other communication interfaces for transmitting and receiving data. Radio station 1105 can include one or more memories (not explicitly shown) configured to store information such as data and/or instructions. In some implementations, the processor electronics 1110 can include at least a portion of the transceiver electronics 1115. In some embodiments, at least some of the disclosed techniques, modules or functions are implemented using the radio station 1105. In some embodiments, the radio station 1105 may be configured to perform the methods described herein.

It will be appreciated that the present document discloses techniques that can be embodied in various embodiments to facilitate connection establishment and management of QoS information in UE-to-UE relay sidelink communications. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
reporting, by a first communication device to a first base station, at least a first part of Quality of Service (QoS) information applicable between the first communication device and a relay communication device, wherein the first communication device is configured to communicate with a second communication device via the relay communication device,
wherein the first part of QoS information includes a packet delay budget that indicates an upper bound value for a packet delay between the first communication device and the relay communication device; and
receiving, by the first communication device, sidelink configuration information that is based on at least the first part of QoS information from the first base station.

2. The method of claim 1, further comprising:
transmitting, by the first communication device, a mapping of one or more QoS flows to one or more data bearers between the first communication device and the second communication device to the relay communication device based on at least the sidelink configuration information.

3. The method of claim 1, wherein the QoS information comprises information about one or more QoS flows, the information comprising at least one of a QoS Flow identifier or a QoS profile associated with a flow, wherein the QoS profile comprises at least one of a PC5 QoS Identifier (PQI), a resource type, a priority level, a packet delay budget, a packet error rate, an averaging window, a maximum data burst volume, a Guaranteed Flow Bit Rate (GFBR), or a Maximum Flow Bit Rate (MFBR).

4. The method of claim 1, wherein the sidelink configuration information comprises at least one of: a Service Data Adaptation Protocol (SDAP) configuration of a sidelink data radio bearer (DRB) between the first communication device and the second communication device, a Packet Data Convergence Protocol (PDCP) configuration of the sidelink DRB between the first communication device and the second communication device, a PC5 Radio Link Control (RLC) bearer configuration between the first communication device and the relay communication device or between the relay communication device and the second communication device, an adaptation layer configuration, a sidelink mode 1 resource allocation, or a sidelink configured grant type 1 resource allocation.

5. A method for wireless communication, comprising:
receiving, by a first base station from a first communication device, at least a first part of Quality of Service (QoS) information applicable between the first communication device and a relay communication device, wherein the first communication device is configured to communicate with a second communication device via the relay communication device,
wherein the first part of QoS information includes a packet delay budget that indicates an upper bound value for a packet delay between the first communication device and the relay communication device; and
transmitting, by the first base station, sidelink configuration information that is based on at least the first part of QoS information to the first communication device.

6. The method of claim 5, wherein the receiving comprises receiving a second part of QoS information applicable between the relay communication device and the second communication device from the first communication device or from the relay communication device,
wherein the second part of QoS information includes a packet delay budget that indicates an upper bound value for a packet delay between the relay communication device and the second communication device, and the method further comprises:
transmitting, by the first base station to the relay communication device, sidelink configuration information that is based on the second part of QoS information.

7. A method for wireless communication, comprising:
receiving, by a relay communication device from a base station, sidelink configuration information that is based on at least a second part of Quality of Service (QoS) information applicable between the relay communication device and a second communication device,
wherein the second part of QoS information includes a packet delay budget that indicates an upper bound value for a packet delay between the relay communication device and the second communication device; and
facilitating a communication between the second communication device and a first communication device by the relay communication device.

8. The method of claim 7, comprising:
receiving, by the relay communication device, a mapping of one or more QoS flows to one or more data bearers between the first communication device and the second communication device.

9. The method of claim 7, further comprising:
reporting, by the relay communication device, relay assistance information to the base station, the relay assistance information comprising at least the second part of QoS information.

10. The method of claim 9, wherein the relay assistance information comprises at least one of the second part of QoS information, an identity of the first communication device, a PC5 RLC bearer configuration for the first communication device, a mapping of one or more PC5 QoS flows to one or more sidelink DRBs between the first communication device and the second communication device, a mapping of the one or more sidelink DRBs between the first communication device and the second communication device to one or more PC5 RLC bearers, an identity of the relay communication device, a relay indication, an identity of the second communication device, or a PC5 QoS profile.

11. A wireless communication apparatus, at least one processor configured to cause the wireless communication apparatus to implement the method of claim 1.

12. The wireless communication apparatus of claim 11, wherein the at least one processor is configured to cause the wireless communication apparatus to transmit a mapping of one or more QoS flows to one or more data bearers between the first communication device and the second communication device to the relay communication device based on at least the sidelink configuration information.

13. The wireless communication apparatus of claim 11, wherein the QoS information comprises information about one or more QoS flows, the information comprising at least one of a QoS Flow identifier or a QoS profile associated with a flow, wherein the QoS profile comprises at least one of a PC5 QoS Identifier (PQI), a resource type, a priority level, a packet delay budget, a packet error rate, an averaging window, a maximum data burst volume, a Guaranteed Flow Bit Rate (GFBR), or a Maximum Flow Bit Rate (MFBR).

14. The wireless communication apparatus of claim 11, wherein the sidelink configuration information comprises at least one of: a Service Data Adaptation Protocol (SDAP) configuration of a sidelink data radio bearer (DRB) between the first communication device and the second communication device, a Packet Data Convergence Protocol (PDCP) configuration of the sidelink DRB between the first communication device and the second communication device, a PC5 Radio Link Control (RLC) bearer configuration between the first communication device and the relay communication device or between the relay communication device and the second communication device, an adaptation layer configuration, a sidelink mode 1 resource allocation, or a sidelink configured grant type 1 resource allocation.

15. A wireless communication apparatus, at least one processor configured to cause the wireless communication apparatus to implement the method of claim 5.

16. The wireless communication apparatus of claim 15, wherein the at least one processor is configured to cause the wireless communication apparatus to receive a second part of QoS information applicable between the relay communication device and the second communication device from the first communication device or from the relay communication device, wherein the second part of QoS information includes a packet delay budget that indicates an upper bound value for a packet delay between the relay communication device and the second communication device; and
wherein the at least one processor is further configured to cause the wireless communication apparatus to transmit sidelink configuration information that is based on the second part of QoS information to the relay communication device.

17. A wireless communication apparatus, at least one processor configured to cause the wireless communication apparatus to implement the method of claim 7.

18. The wireless communication apparatus of claim 15, wherein the at least one processor is configured to cause the wireless communication apparatus to received a mapping of one or more QoS flows to one or more data bearers between the first communication device and the second communication device.

19. The wireless communication apparatus of claim 15, wherein the at least one processor is configured to cause the wireless communication apparatus to report relay assistance information to the base station, the relay assistance information comprising at least the second part of QoS information.

20. The wireless communication apparatus of claim 19, wherein the relay assistance information comprises at least one of the second part of QoS information, an identity of the first communication device, a PC5 RLC bearer configuration for the first communication device, a mapping of one or more PC5 QoS flows to one or more sidelink DRBs between the first communication device and the second communication device, a mapping of the one or more sidelink DRBs between the first communication device and the second communication device to one or more PC5 RLC bearers, an identity of the relay communication device, a relay indication, an identity of the second communication device, or a PC5 QoS profile.
